(19) United States
(12) Patent Application Publication
(10) Pub. No.: US 2010/0088381 A1
(43) Pub. Date: Apr. 8, 2010

(54) METHOD AND SYSTEM FOR MANAGING AN E-MAIL FLOW

(75) Inventor: Laurent Deslandres, Paris (FR)

Correspondence Address: YOUNG & THOMPSON, 209 Madison Street, Suite 500, Alexandria, VA, 22314, US

(73) Assignee: NEXSTAGE, Paris (FR)

(21) Appl. No.: 12/522,747

(22) PCT Filed: Dec. 13, 2007
(86) PCT No.: PCT/FR2007/052505

§ 371 Date: Jul. 10, 2009

(30) Foreign Application Priority Data
Jan. 10, 2007 (FR) 0700145

(51) Int. Cl. G06F 15/16

(52) U.S. Cl. 709/206

(57) ABSTRACT

A method for managing an e-mail flow between a plurality of messaging accounts (11, 13), includes the following steps: using a statistical study of the data relating to at least one messaging account (11, 13) among the plurality of messaging accounts (11, 13); determining at least one predetermined indicator concerning the messaging account (11, 13); based on the predetermined indicator and on at least one predetermined level associated with the indicator, determining at least one index relating to a state of the messaging account (11, 13); based on the index and on a predetermined level associated with the index, triggering a so-called alarm signal corresponding to the state of the messaging account (11, 13); based on the alarm signal, triggering at least one so-called management action for quantitatively reducing the e-mail flow with the messaging account (11, 13).

The present invention relates to a method for managing email flows with respect to an email account.

The majority of the current tools for managing flows or exchange of emails generally has the main aim of applying a usage chart to email use and ensuring that email account usage quotas are respected in terms of volume, in order to limit the size of email boxes and thus email storage capacities. These tools are essentially based on an analysis of incoming and outgoing emails, combined with management of lists of denied email addresses, usually called “blacklists”.

The administrator is alerted to each exchange of emails with an email address present in the blacklist. Thus it is possible to define several lists of email addresses and to provide management of these lists as well as a predefined processing to be undertaken at each exchange of emails with an address present in one of these lists. These tools are particularly focussed on regulating emails, with concern for maintaining confidentiality, security and ethics.

Among the tools for managing email flows, anti-spam tools can also be mentioned, which are well known to a person skilled in the art.

Other tools for managing email flows are proposed, such as those disclosed in the document US20060075048A1. This document discloses a method and a system for detecting and blocking unwanted emails by measuring the flow of emails sent by a sender. If the flow of emails exceeds a predetermined threshold, the emails sent by this sender are classified as unwanted and are blocked.

However, none of the current tools seems to have been designed for the purpose of a quantitative reduction in the exchange of emails within a group, while aiming for qualitative improvement of these exchanges.

The purpose of the present invention is to propose a method for managing email flows which is intended to bring about a quantitative reduction in email flows.

A further purpose of the present invention is to propose a method for managing email flows so as to increase the quality of the exchanges.

The invention proposes to achieve this aim by a method for managing email flows between a plurality of email accounts, comprising the following steps:
determining, by statistical study of data relating to at least one email account from said plurality of email accounts, at least one predefined indicator relating to said email account;
determining, in relation to said predefined indicator and at least one predetermined level associated with said indicator, at least one index relating to a state of said email account;
triggering, in relation to said index and a predetermined level associated with said index, a signal called an alarm signal corresponding to said state of said email account; and
according to said alarm signal, triggering at least one operation, called a management operation, intended to quantitatively reduce the flow of emails relating to said email account.

Following a statistical study of the incoming and outgoing flows of the email account, the invention makes it possible to trigger an alarm signal taken into account for the management of email exchanges carried out by the email account with at least one email account. The invention makes it possible to determine indicators based on the incoming and/or outgoing flows during exchanges of emails carried out by the email account, so as to limit the quantity of emails exchanged, while aiming to increase the quality of these exchanges.

The alarm signal can be, for example, a visual alarm signal which can have several colours, each corresponding to one of several alarm levels according to the value of the index in relation to the state of the corresponding email account.

The management operation depends at least on the state of the email account. As will be seen in the remainder of this description, the management operation can also take into account the state of at least one other email account with which the email account is carrying out an exchange. In the remainder of the description, further details will be given on the nature of the management operation.

By exchange of emails is meant a flow of emails generated by an operation of sending an email to an email account or receiving an email sent by at least one other email account.

In a first embodiment, the email account is an account called a recipient account, intended to receive at least one email sent by at least one email account called a sender account.

In this first embodiment, at least one indicator can correspond to an indicator called the reception indicator, determined by the statistical study of all or some of the emails previously received by the recipient email account over a predetermined period.

At least one reception indicator can relate to a number of emails received, to a predefined email processing operation carried out on all or some of the emails received or also to at least one reception mode of at least some of the emails received.

By email processing operation is meant any operation which can be carried out on an email, such as a read, reply, forwarding or deletion operation. Thus a reception indicator can be determined by a statistical study of emails to which, within a predetermined time span after sending, the addressees have or have not replied, which they have or have not forwarded, have or have not read, have or have not deleted, or on which they have performed a combination of these operations, or also by a statistical study of the duration between the sending of a message and its processing.

By reception mode of an email is meant reception of an email as recipient, carbon copy recipient (CC) or blind copy recipient (BC). Thus a reception indicator can be determined by a statistical study of emails received as direct recipient, or CC recipient, or BC recipient.

Also in this first embodiment, the index can correspond to an index called a saturation index, relating to a receiving state of the recipient email account. This saturation index is calculated from the reception indicators on the basis of emails received by the recipient email account.

Moreover, the method according to the invention can comprise a determination of at least one saturation index for one category of emails received, from a plurality of predefined categories, said determination being carried out according to indicators relating to said category. For example, a first saturation index can be calculated taking into account all the indicators. Another index can be calculated taking into account only the indicators which are not determined in relation to a processing operation.

The method according to the invention can comprise a triggering of an alarm signal associated with a saturation index. The triggering of this alarm signal can relate to a relative or absolute index level. This alarm signal can be, for example, a visual alarm signal which can have several colours, each corresponding to one of several alarm levels according to the value of the corresponding saturation index in relation to the state of the recipient email account.

Advantageously, the management operation can comprise at least one operation selected from the following list:
displaying an item of information relating to the alarm signal corresponding to the state of the recipient account at the level of at least one sender email account capable of potentially sending at least one email to said recipient email account.
blocking the sending of emails to the recipient email account; and
requesting confirmation of sending from the sender email account desiring to send an email to the recipient email account.

Of course, this list is not exhaustive and similar operations well known to a person skilled in the art can be added.

The method according to the invention can moreover comprise a display of an item of information relating to the alarm signal and/or the saturation index of the recipient email account at the level of at least one sender email account capable of potentially sending at least one email to said recipient email account. This display can be carried out at any time, either when the saturation index reaches a predetermined level, or when the saturation signal is in a predetermined state.

Also in this first embodiment, the sending of an email by at least one sender email account, intended to be received by the recipient email account, depends upon the saturation index of said recipient email account. Thus if the saturation index of the recipient email account exceeds a predefined level (or the saturation alarm signal is in a predetermined state), then it is possible for the email not to be sent, or a request for confirmation of sending can be made to the sender email account. This sender account can thus decide to accept or refuse the sending of an email to the “saturated” email account.

Further, when the saturation index (or the saturation alarm signal) of the recipient account has reached a predetermined level, an information message can be displayed at the level of the sender email account as a deterrent to sending an email.

The method according to the invention can also comprise verification of a condition relating to the declared state of absence of the addressee associated with the recipient email account and use of this information in addition to the information concerning the saturation in order to determine the management operation to be carried out.

According to a second embodiment of the method according to the invention, the email account is an account called a sender account intended to send at least one email to at least one email account called a recipient account.

In this second embodiment, at least one indicator can correspond to an indicator called the send indicator determined by the statistical study of all or some of the emails previously sent by the sender email account over a predetermined period.

At least one send indicator can relate to a number of emails sent, to at least one predefined processing operation carried out on all or some of the emails sent, and/or to at least one sending mode of at least some of the emails sent.

By email processing operation is meant any operation which can be carried out by a recipient email account on an email sent by the sender email account, such as a read, reply, forwarding or deletion operation. Thus a send indicator can be determined by a statistical study of emails to which, within a predetermined time span after sending, the addressees have or have not replied, which they have or have not forwarded, which they have or have not read, which they have or have not deleted, or a combination of these operations, or also by a statistical study of the duration between the sending of a message and its processing.

By sending mode of an email is meant a sending of an email to an email account as a direct addressee, carbon copy addressee (CC) or as a blind copy (BC). Thus a send indicator can be determined by the statistical study of emails sent to an email account of a direct addressee, or CC addressee, or also (BC) addressee.

Also in the second embodiment, the index corresponds to an index called a pollution index, relating to a sending state of emails from the sender email account. This pollution index can be calculated as a function of send indicators, optionally taking into account the saturation state of the recipient account(s).

Moreover, the method according to the invention can comprise a determination of at least one pollution index for a category of emails sent among a plurality of predefined categories, said determination being carried out in relation to indicators relating to said category. For example, a first saturation index can be calculated by taking into account all the indicators. Another index can be calculated by taking into account only the indicators which are not determined in relation to a processing operation.

The method according to the invention can comprise a triggering of an alarm signal associated with a pollution index. The triggering of this alarm signal can relate to a relative or absolute index level. The alarm signal can be, for example, a visual alarm signal which can have several colours, each corresponding to one of several alarm levels according to the value of the corresponding pollution index in relation to the state of the recipient email account.

The management operation can comprise at least one operation selected from the following list:
a display of an item of information relating to the alarm signal corresponding to the state of the sender account at the level of at least one recipient email account capable of potentially receiving at least one email sent by said sender email account.
at least one partial prohibition of sending emails by the sender email account; or
a request for confirmation of sending emails to the sender email account.

Of course, this list is not exhaustive and can be added to by similar operations well known to a person skilled in the art.

The method according to the invention can moreover comprise a display of an item of information relating to the alarm signal and/or the pollution index of the sender email account at the level of at least one recipient email account capable of potentially receiving at least one email sent by said sender email account. This display can be carried out at any time, either when the pollution index reaches a predetermined level, or when the pollution alarm signal is in a predetermined state.

Also in this second embodiment, the sending of an email intended to be sent by the sender email account to at least one recipient email account depends on the pollution index of said email account. Thus if the pollution index of the email account exceeds a predefined level (or the pollution alarm signal is in a predetermined state), then it is possible for the email not to be sent or not to be sent to certain addressees, or a request for confirmation of sending to all or some of the addressees can be made. An information message can be displayed at the level of the sender email account in order to deter it from sending an email to at least one addressee.

Advantageously, the method according to the invention can be implemented in order to manage the flows of emails between at least one sender email account and at least one recipient email account, said management being carried out in relation to at least one pollution index relating to said sender account and/or to at least one saturation index relating to said recipient account. Thus the management of an exchange of emails, consisting for example of sending an email from a sender email account to at least one recipient email account, comprises the steps of:
determining at least one pollution index of said sender email account, and
determining at least one saturation index of said recipient email account
   these steps being previous to the exchange in question; then at the time of the exchange:
verifying the state of at least one alarm signal associated with each of said indices of saturation and pollution at the time of the exchange, and
triggering at least one operation managing the exchange.

The management operation can be at least any one of the management operations mentioned in the above-described first and second embodiments. Thus the management operation can be (i) sending an email accompanied or not by display of a warning message relating to the index in question or to the alarm signals, (ii) blocking the sending to all or some of the addressees, or a request for confirmation of sending to all or some of the addressees. The sending confirmation operation can be blocking (mandatory) or deterrent, for example by sending a confirmation request message. The displayed message can contain an item of warning information.

Advantageously, the method according to the invention can comprise a verification of a condition relating to the declared state of presence of the addressee associated with the recipient email account.

The method according to the invention can also comprise a display at the level of the sender email account of at least one item of information relating to the state of presence and/or saturation of at least one recipient email account.

Moreover, the method according to the invention can be implemented for managing exchanges of emails between a plurality of email accounts forming at least one group of email accounts.

According to another feature of the invention, a system for managing the flow of emails between a plurality of email accounts is proposed comprising:
means for determining, by a statistical study of data relating to at least one email account from said plurality of email accounts, at least one predefined indicator relating to said email account;
means for determining, in relation to said predefined indicator and at least one predetermined level associated with said indicator, at least one index relating to a state of said email account;
means for triggering, in relation to said index and a predetermined level associated with said index, a signal called an alarm signal corresponding to said state of said email account; and
means for triggering at least one operation, called a management operation, intended to quantitatively reduce the email flows relating to said email account, in relation to said alarm signal.

The system according to the invention can be implemented in order to manage flows of emails between at least one sender email account and at least one recipient email account, said management being carried out in relation to at least one pollution index relating to said sender account and/or at least one saturation index relating to said recipient account. More generally, the system according to the invention can be implemented for managing exchanges of emails between a plurality of email accounts forming at least one group of email accounts.

Advantageously, the system according to the invention can comprise:
means for displaying, at the level of the sender email account, at least one item of information relating to the state of pollution of the email account.
means for displaying, at the level of the sender email account, at least one item of information relating to the state of presence and/or saturation of at least one recipient email account.

Means constituting the system according to the invention can at least in part have an electronic and/or data processing nature and comprise software means.

Other advantages and features will become apparent on inspection of the detailed description of an embodiment which is in no way limitative and the figures in which:

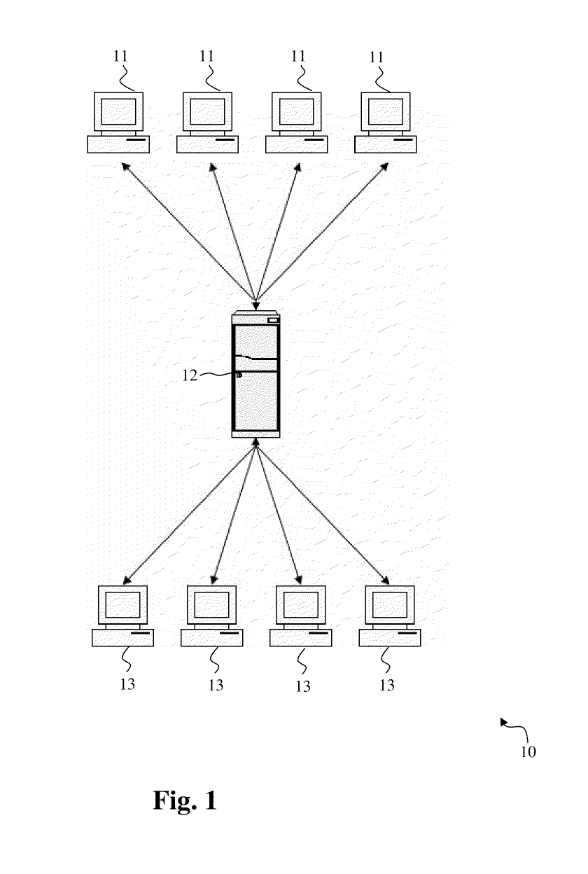

FIG. 1 is a diagrammatic representation of a plurality of email accounts forming a group of email accounts, the email exchange management of which is carried out using the method according to the invention;

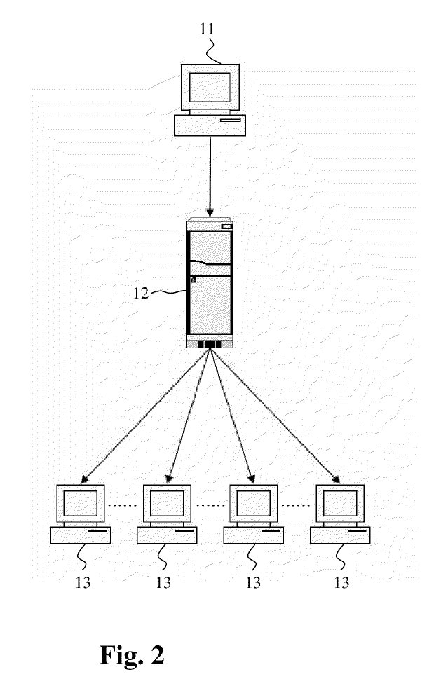

FIG. 2 is a diagrammatic representation of an email account sending an email to a plurality of recipient email accounts;

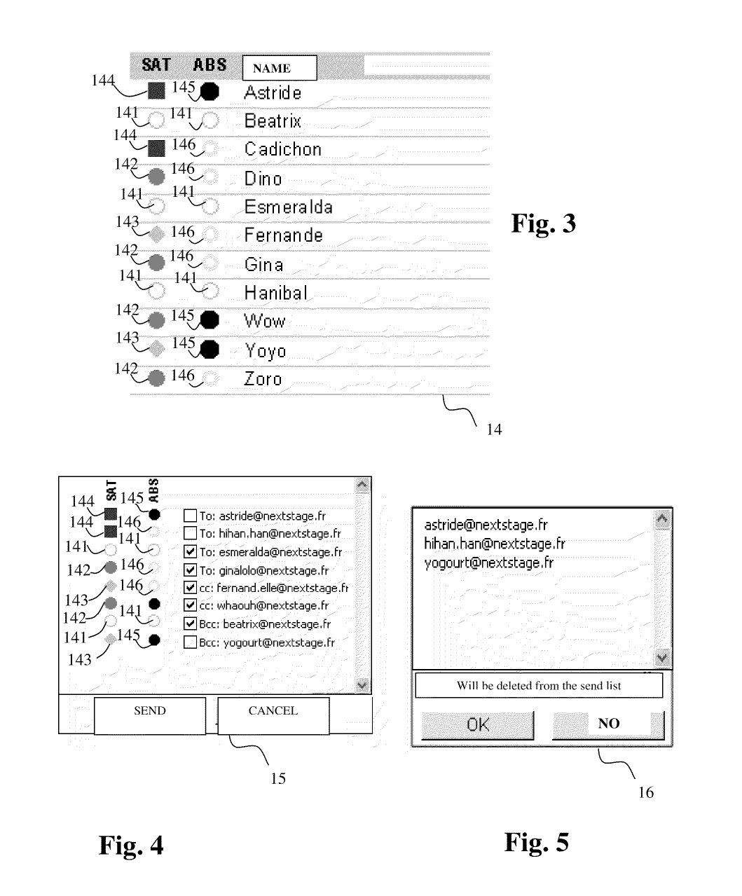

FIG. 3 is an example of a window displaying the declared saturation and absence state of a plurality of email accounts; and

FIGS. 4 and 5 are an example of windows confirming the sending of an email to a plurality of recipient email accounts according to their declared saturation and absence state.

The embodiment of the invention described below relates to the management of email exchanges within a group 10 of several users each having a sender and/or recipient email account 11, 13. The exchanges of emails between users are carried out via a server 12 which manages the exchanges.

For each email account 11, 13, the parameters taken into account are the following:
User ID: identifier of the user 11, 13 of the account;
Group IDs: identifier of the group;
ProfileIN: number of the set of parameters to be used for calculating the predefined acceptable reception level for emails;
ProfileOUT: number of the set of parameters to be used for calculating the predefined acceptable sending level for emails;
Parameter giving information on the status of the user 11, 13: active or non-active.

The parameters used for each email are:
Mail ID: identifier of the email;
SenderID: identifier of the sender of the email (if the sender is active, if not, the identifier takes the value “unknown”);
RecipientID: identifier of the recipient of the email (if the recipient is active, if not, the identifier takes the value “unknown”);
Attachment (presence/absence)
Date and Time of sending;
Date and Time of opening;
Date and Time of opening the attachment;
Date and Time read;
Date and Time of reply;
Date and time of forwarding;
Date and time of deletion;
Sending type (main addressee “A”, carbon copy addressees “Cc”, blind copy addressees “Bc”.
declared absence parameter ABS
Saturation state SAT which can take the following values: non-saturated, yellow, red; and
State of pollution POL which can take the following values: non-polluting, yellow, red.
   The calculation for the SAT and POL parameters is detailed below.

### Calculation of the Saturation Index “SAT”

For each active recipient, the following statistical and reception indicators are determined:
R1: Total number of emails received as main addressee “A”;
R2: Total number of emails received as “Cc” or “Bc” addressee;
R3: Total number of emails awaiting processing in the inbox;
R4: Total number of unprocessed emails (unopened, unread, not deleted, not forwarded) in a time span of Sd days;
R5: Total number of unread, non-forwarded emails deleted in a time span of Sd days;
R6: Total number of unread emails forwarded in a time span of Sd days;
R7: Total number of emails received as addressee “A” opened but not replied to in a time span of Sd days;
R8: Average reply times to an email received as addressee “A” and replied to within a time span of Sd days;

The emails are accounted for over a rolling period of Nd days. Typically and by way of a non-limitative example, Sd=7 days and Nd=28 days. It must be noted that Sd and Nd can be configured.

All or some of these above-mentioned indicators are used for the calculation of a saturation index. They can also be used for other statistical calculations. Calculation of the saturation index is carried out in the following fashion. A level called a “standard level” corresponds to each indicator. This “standard level” is defined as the average or median value of this indicator over all users, or the value of the highest or lowest X %, X being a predetermined value, or also any other predefined arbitrary value.

For each user profile, the acceptable reception level for emails ProfileIN comprises a “factors” group and a “weight” group. A “Reference Level” for each indicator is calculated from these defined factors and weight, using the following formula:

Reference Level=standard_level×factor×weight

except for the parameter R8, for which the Reference Level is always 0. The table below is an example of calculation of the Reference Level for parameters R1-R8.

| | | | | Processing carried out by the | | | | |
|---|---|---|---|---|---|---|---|---|
| | | | | recipient after Sd days (e.g. 7 days) | | | | |
| | Indicators | | | | | | | |
| | R1 | R2 | R3 | R4 | R5 | R6 | R7 | R8 |
| Standard | 1000 | 2000 | 20 | 0 | 0 | 0 | 200 | 24:00 |
| level | | | | | | | | |
| Factor for | 100% | 150% | 150% | 100% | 100% | 100% | 100% | 100% |
| ProfileIN1 | | | | | | | | |
| Weight for | 1 | 0.5 | 5 | 1 | 1 | 1 | 2 | 1 |
| ProfileIN1 | | | | | | | | |
| reference | 1000 | 1500 | 150 | 0 | 0 | 0 | 400 | 0 |
| level | | | | | | | | |

The data relating to the recipient, “Recipient's data” (as well as the “standard level”) is the data taken into consideration over a predetermined period of Nd days. Nd is typically 28 days.

A volume for each reception indicator is then calculated using the formula

Volume=recipient's_data×weight

except for R8 which is calculated with the following formula:

(recipient's_data−standard_level×factor)×(Number of emails to which a reply has been made/(Nd−Sd))×weight.

The unit of calculation for the indicator R8 is 1 day, but the display can be in the form Hour:minutes. The table below gives an example of this calculation.

| | | | | Processing carried out by the | | | | |
|---|---|---|---|---|---|---|---|---|
| | | | | recipient after Sd days (e.g. 7 days) | | | | |
| | Indicators | | | | | | | |
| | R1 | R2 | R3 | R4 | R5 | R6 | R7 | R8 |
| recipient's | 1712 | 2832 | 97 | 27 | 256 | 101 | 347 | 18:54 |
| data | | | | | | | | |
| Weight | 1 | 0.5 | 5 | 1 | 1 | 1 | 2 | 1 |
| ProfileIN1 | | | | | | | | |
| Volume | 1712 | 1416 | 485 | 27 | 256 | 101 | 694 | −207.9 |

Several saturation indices are calculated from the “Volume” data obtained. “Alarm Levels” are defined at the same time. The alarm levels and the saturation indices can be defined in various ways:

Alarm level:
Ratio: determined by the Administrator. In the case where ratio=1, the alarm level is equal to the Reference level;
Absolute: sum (reference_level)×ratio;
Relative: Determined by the Administrator.
   Saturation index:
Ratio: sum(volume)/sum(reference_level). (A ratio greater than 1 means a saturation level greater than the “reference level”).
Absolute: sum (volume)
Relative: rank/total number of users (the first rank corresponding to the maximum value)

One of these indices is chosen by the administrator in order to determine the saturation state SAT. A saturation signal is sent when the saturation index exceeds a predefined level (above the Absolute or Ratio saturation index or below the Relative saturation index. The table below gives an example of calculation of the saturation index and of sending a saturation signal.

| | yellow | | | Red | | |
|---|---|---|---|---|---|---|
| | Absolute | Ratio | Relative | Absolute | Ratio | Relative |
| Alarm | 2650 | 1 | 20% | 6100 | 2 | 10% |
| Level | | | | | | |
| Saturation | 3613 | 1.36 | 11.3% | 4483 | 1.47 | 9.7% |
| index | | | | | | |
| Saturation | TRUE | TRUE | FALSE | FALSE | FALSE | TRUE |
| signal | | | | | | |
| “SAT” | | | | | | |

The red saturation index is calculated on the basis of all the indicators. The yellow saturation state is calculated on the basis of the indicators which do not take into account the processing carried out by the recipient. The red saturation state has priority over the yellow saturation state.

### Calculation of the “POL” Pollution Index

The following statistical indicators are calculated for each sender:
Total number of emails sent: internally (to active users), externally (to inactive users) [*];
Total number of addressees: “A”, “Cc”, “Bc” [*];
Average number of addressees “A”, “Cc” per email [*];
Total number of addressees for messages comprising an attachment [*]

The following statistical and pollution indicators are calculated for each sender:
E1/E1Y/E1R: Number of “non-saturated” “A” addressees having a “Y-saturated” yellow saturation state and having an “R-saturated” red saturation state.
E2/E2Y/E2R: Idem E1 for the “Cc” addressees;
E3: number of emails having undergone no processing (unopened, unread, not deleted, not forwarded) in a time span of Sd days;
E4: number of unopened or non-forwarded but deleted emails in a time span of Sd days;
E5: number of unopened but forwarded emails in a time span of Sd days;
E6: for the “A” addressees, the number of emails opened but not replied to in a time span of Sd days;
E7: for the “A” addressees, the “median delay” between the date of sending and the date of reply; based on the emails to which a reply has been made within a time span of Sd days.

The indicators marked with [*] are calculated for statistical studies only. The emails are taken into account over a rolling period of Nd days. Typically and by way of a non-limitative example, Sd=7 days and Nd=28 days. It must be noted that Sd and Nd can be configured.

A “pollution index” is calculated in relation to all or some of these indicators. For calculating the pollution index, for each pollution index there are used:
factors and weights;
a “reference level” and
a “standard level”.

Then a volume is calculated in relation to the sender's data. The tables below give an example of this calculation.

| | | | | | | | Processing carried out by the recipient | | | | |
|---|---|---|---|---|---|---|---|---|---|---|---|
| | | | | | | | after Sd days (e.g. Sd = 7 days) | | | | |
| | indicators | | | | | | | | | | |
| | TO: | TO: | TO: | CC: | CC: | CC: | | | | | |
| | non-SAT | Y-SAT | R-SAT | non-SAT | Y-SAT | R-SAT | E3 | E4 | E5 | E6 | E7 |
| standard | 2000 | 200 | 100 | 4000 | 400 | 200 | | 0 | 0 | 200 | 24:00 |
| level | | | | | | | | | | | |
| factors | 50% | 50% | 10% | 50% | 50% | 10% | 100% | 100% | 100% | 100% | 100% |
| ProfileOUT1 | | | | | | | | | | | |
| Weight | 1 | 2 | 4 | 1 | 2 | 4 | 1 | 2 | 1 | 1 | 1 |
| ProfileOUT1 | | | | | | | | | | | |
| reference | 1000 | 200 | 40 | 2000 | 400 | 80 | 0 | 0 | 0 | 200 | |
| level | | | | | | | | | | | |

| | | | | | | | Processing carried out by the recipient | | | | |
|---|---|---|---|---|---|---|---|---|---|---|---|
| | | | | | | | after Sd days (e.g. 7 days) | | | | |
| | indicators | | | | | | | | | | |
| | TO: non | TO: | TO: | CC: | CC: | CC: | | | | | |
| | SAT count | Y-SAT | R-SAT | non-SAT | Y-SAT | R-sat | E3 | E4 | E5 | E6 | E7 |
| sender's data | 2931 | 278 | 148 | 4988 | 611 | 203 | 251 | 257 | 352 | 227 | 29:14 |
| weight | 1 | 2 | 4 | 1 | 2 | 4 | 1 | 2 | 1 | 1 | 1 |
| ProfileOUT1 | | | | | | | | | | | |
| Volume | 2931 | 556 | 592 | 4988 | 1222 | 812 | 251 | 514 | 352 | 227 | 70.71 |

Several pollution indices are calculated. This calculation is carried out in a similar fashion to the calculation of the saturation index. However, the yellow and red saturation states are both calculated on the basis of all the pollution indicators.

One of these indices is chosen by the administrator to determine the pollution state POL. A pollution signal is sent when the pollution index exceeds a predefined level (above the Absolute or Ratio pollution index or below the Relative pollution index). The table below gives an example of calculation of the pollution index and of sending a saturation signal.

| | yellow | | | Red | | | |
|---|---|---|---|---|---|---|---|
| | Absolute | Ratio | Relative | Absolute | Ratio | Relative | Trend |
| Alarm Level | 3720 | 1 | 20% | 7840 | 2 | 10% | 5% |
| Pollution index | 12516 | 3.36 | 11.3% | 12516 | 1.60 | 9.7% | −7.3% |
| Pollution Flag | TRUE | TRUE | FALSE | FALSE | FALSE | TRUE | + |

Further, a “trend” tendency for the sender activity is calculated over two periods of Td days. This calculation is performed as follows:

Trend=(Td current/Td previous)−1

The invention comprises sending a warning notice when an email is sent and certain conditions are fulfilled. The invention can also comprise a de-selection of one or more addressees according to certain conditions. To this end, the invention implements a table of warnings containing warning conditions and warning messages, and conditions for de-selection of an addressee at the time of sending an email. In the present example, these conditions are based on the pollution status and the ProfileOut parameter.

Each time a message is sent, these conditions are tested. Such a table appears as follows:

| Pollution | Warning | | De-selection |
|---|---|---|---|
| Status | condition | Warning message | condition |
| None | | | |
| Yellow | | | |
| Red | | | |

Warning condition corresponds to a condition table for the sending or display of a message.

Warning message corresponds to the warning message when the corresponding warning conditions are verified.

De-selection condition corresponds to a condition table for the de-selection of one or more addressees at the time of sending an email.

The tables of conditions contain a number of addressees to be reached or exceeded in one category for a condition to be verified. The different categories are for example:
Addressee in a red saturation state “Red saturated”
Addressee in a Red or Yellow saturation state “red+yellow saturated”;
Addressee in a Red or Yellow saturation state and absent “red+yellow saturated ABSent”;

The table below gives an example of a condition table.

| Condition table | General | ABSent |
|---|---|---|
| Red saturated | | |
| Yellow + Red saturated | 0 | |
| Active users (total) | | 3 |
| All users | | n/a |

In this example, the condition is verified if an email is sent to more than 3 absent users or to 1 or more users whose saturation state is yellow or red, whether absent or not. In the case of a conflict between different conditions, the more restrictive condition applies.

The order of de-selection is defined in another table:

| Order of de-selection | | non-ABSent | ABSent |
|---|---|---|---|
| Red saturated | “Cc”/“Bc” | 3rd | 1^{st} |
| | “A” | 4th | 2^{nd} |
| Yellow + Red saturated | “Cc”/“Bc” | 7th | 5^{th} |
| | “A” | 8th | 6^{th} |
| other active users | “Cc”/“Bc” | 13th | 9^{th} |
| | “A” | 14th | 10^{th} |
| other addressees | “Cc”/“Bc” | 11th | |
| | “ [symbol] A [symbol] | 12th | |

The parameters to be set for the satisfactory operation of the method according to the invention are as follows:
“standard level” for each reception indicator;
“standard level” for each send indicator;
the ProfileIN factors for the reception indicators
the ProfileOUT factors for the send indicators
the ProfileIN weight for the reception indicators
the ProfileOUT weight for the send indicators.

The table below gives an example of the configuration of the reception indicators for 3 user profiles.

| | Reception Indicators | | | | | | | |
|---|---|---|---|---|---|---|---|---|
| | R1 | R2 | R3 | R4 | R5 | R6 | R7 | R8 |
| Standard | median | median | top 75% | 0 | 0 | top 60% | 200 | 24:00 |
| level | | | | | | | | |
| ProfileIN1 | 100% | 150% | 0% | 0% | 0% | 100% | 100% | 125% |
| Factors | | | | | | | | |
| ProfileIN2 | 50% | 100% | 50% | 0% | 0% | 200% | 50% | 50% |
| Factors | | | | | | | | |
| ProfileIN3 | 200% | 500% | 100% | 0% | 0% | 400% | 0% | 250% |
| Factors | | | | | | | | |
| ProfileIN1 | 3 | 1 | 3 | 1 | 1 | 2 | 1 | 2 |
| Weight | | | | | | | | |
| ProfileIN2 | 3 | 1 | 3 | 1 | 1 | 2 | 1 | 2 |
| Weight | | | | | | | | |
| ProfileIN3 | 1 | 0 | 1 | 1 | 0 | 2 | 0 | 4 |
| Weight | | | | | | | | |

The following must also be set:
For each ProfileIN, the yellow and red saturation alarm levels as well as the saturation index chosen for triggering a saturation signal
For each ProfileOUT, the yellow and red pollution alarm levels, as well as the pollution index chosen for triggering a pollution signal
For each ProfileOUT, the warning and de-selection conditions and the warning messages.
The time spans used for the calculations; for example Sd=7 days.

The numbers of the set of parameters to be used for the “ProfileIN” and “ProfileOUT” profiles can be defined for each user and/or each group of users.

FIG. 2 is a representation of a sender email account 11 wishing to send an email to a plurality of recipient email accounts 13 via the server 12. The server 12 comprises a module for calculating the pollution state of the sender account 11 as well as the saturation state of the recipient email accounts 13. The address book of the email account 11 can comprise additional fields to display declared saturation and absence information of the recipient email accounts 13. Table 14 of FIG. 3 gives an example of an address book according to the invention. In table 14 shown in FIG. 3:
The visual flag 141 corresponds to a “non-active user”;
The visual flag 142 corresponds to a “non-saturated state user”;
The visual flag 143 corresponds to a “yellow saturated state user”;
The visual flag 144 corresponds to a “red saturated state user”;
The visual flag 145 corresponds to an “absent user”;
The visual flag 146 corresponds to a “user not denoted as absent”;

Of course, these flags can have different colours and shapes for easy reading of the information that they carry.

Now a description will be given of sending email from the sender account 11 to the recipient accounts 13. When the email is ready to be sent to several addressees, the information on the saturation (“SAT”) and absence (“ABS”) state of each addressee is provided to the sender using an information window 15 shown in FIG. 4. It should be noted that this display has an optional character and is not mandatory if there are no de-selections.

The proposed de-selections are in relation to the polluter state of the sender email account 11. The user can then accept the proposed de-selections: in this example, the red saturated addressees as well as the addressees that are both yellow saturated and absent are de-selected. The user can also have the option of re-selecting one or more of the de-selected addressees (or of de-selecting others). Then a de-selection confirmation window 16, shown in FIG. 5, displays the de-selected addressees. Then the email is sent to the addressees that have not been de-selected.

The saturation and pollution indices as well as certain statistical elements can be communicated to each user in order to inform them with respect to their activity. Thus each user can receive or have access to this information at any time, presented in the form of one or more tables such as the tables below:

| | |
|---|---|
| Your pollution index | trend |

| | | | |
|---|---|---|---|
| ▪ | 3.05 | [symbol] | −7.3 |

Your saturation index

| | |
|---|---|
| [symbol] | 0.87 |

| | | The last | Last working |
|---|---|---|---|
| Activity report (emails sent) | | 28 days | day |
| To very saturated email accounts | [symbol] | 60 | 7 |
| To saturated email accounts | [symbol] | 71 | 11 |
| To ABSent email accounts | [symbol] | 37 | 3 |
| To external email accounts | [symbol] | 720 | 46 |
| To internal email accounts | [symbol] | 475 | 33 |
| Average number of addressees per email | | 2.2 | 1.7 |

action of the addressees of your emails (*)

| | |
|---|---|
| Read but not replied | 12% |
| Deleted without being read or forwarded | 7% |
| Forwarded without being read | 14% |
| Disregarded (no action) | 9% |
| Average reply time (in hours) | 27.4 |

(*) Emails received between D-28 and D-7

Processing carried out on received emails (*)

| | |
|---|---|
| Read but not replied | 8% |
| Deleted without being read or forwarded | 0% |
| Forwarded without being read | 11% |
| Disregarded (no action) | 1% |
| Average reply time (in hours) | 12.4 |

(*) Emails received between D-28 and D-7

| | | The last | Last working |
|---|---|---|---|
| Activity report (emails received) | | 28 days | day |
| As addressee “A” | [symbol] | 50 | 4 |
| As addressee “Cc” or “Bc” | ◯ | 33 | 1 |
| Total number of emails waiting | [symbol] | 3 | 2 |

The method according to the invention can thus comprise, for statistical purposes, a study of the exchange of emails between several predefined groups. The statistics can use the above-described indicators.

Of course, the invention is not limited to the examples and embodiments that have just been described.

1. Method for managing email flows between at least one sender email account (11) and at least one recipient email account (13), the state of at least one of said email accounts being known, said method comprising the following steps:
determining, by a statistical study of data relating to the past activity of the email account the state of which is known (11, 13), at least one predefined indicator relating to said email account (11, 13);
determining, in relation to said predefined indicator and at least one predetermined level associated with said indicator, at least one index relating to the past activity of said email account the state of which is known (11, 13);
triggering, according to said index and a predetermined level associated with said index, a signal called an alarm signal corresponding to the state of said email account the state of which is known (11, 13); and
according to said alarm signal, triggering at least one operation, called a management operation, intended to quantitatively reduce the flow of emails relating to said email account the state of which is known (11, 13).

2. Method according to claim 1, characterized in that the email account the state of which is known is the recipient account (13) intended to receive at least one email sent by at least one sender email account (11).

3. Method according to claim 2, characterized in that at least one indicator corresponds to an indicator called the reception indicator, determined by the statistical study of all or some of the emails previously received by the recipient email account (13) over a predetermined period.

4. Method according to claim 3, characterized in that at least one reception indicator relates to a number of emails received, to a predefined email processing operation carried out on all or some of the emails received and/or to at least one reception mode of at least some of the emails received.

5. Method according to claim 2, characterized in that the index corresponds to an index called a saturation index (SAT) relating to a reception state of the recipient email account (13).

6. Method according to claim 2, characterized in that the management operation comprises at least one operation selected from the following list:
displaying an item of information relating to the alarm signal corresponding to the state of the receiving account at the level of at least one sender email account capable of potentially sending at least one email to said recipient email account.
blocking the sending of emails to the recipient email account (13); and
requesting confirmation of sending from a sender email account (11) desiring to send an email to the recipient email account (13).

7. Method according to claim 1, characterized in that the email account the state of which is known is the sender account (11) intended to send at least one email to at least one recipient email account (13).

8. Method according to claim 7, characterized in that at least one indicator corresponds to an indicator called the send indicator, determined by a statistical study of all or some of the emails previously sent by the sender email account (11) over a predetermined period.

9. Method according to claim 8, characterized in that at least one send indicator relates to a number of emails sent, to at least one predefined processing operation carried out on all or some of the emails sent, and/or to at least one sending mode of at least some of the emails sent.

10. Method according to claim 7, characterized in that the index corresponds to an index called a pollution index relating to a sending state of the sender email account (11).

11. Method according to claim 7, characterized in that the management operation comprises at least one operation selected from the following list:
a display of an item of information relating to the alarm signal corresponding to the state of the sender account (11);
at least one partial prohibition of sending emails by the sender email account (11); and
a request for confirmation of sending emails to the sender email account (11).

12. Method according to claim 1, characterized in that it is implemented for managing the flows of emails between at least one sender email account (11) the state of which is known and at least one recipient email account (13) the state of which is known, said management being carried out in relation to at least one pollution index relating to said sender account (11) and/or at least one saturation index (SAT) relating to said recipient account (13).

13. Method according to claim 2, characterized in that the management comprises taking into account a known absence state (ABS), declared or not, of a user of the recipient email account (13).

14. Method according to claim 7, characterized in that it also comprises a display at the level of the sender email account (11) of at least one item of information relating to its pollution state.

15. Method according to claim 12, characterized in that it also comprises a display at the level of the sender email account (11) of at least one item of information relating to the declared state of absence (ABS) and/or saturation (SAT) of at least one recipient email account (13).

16. System for managing the flow of emails between at least one sender email account (11) and at least one recipient email account (13), the state of at least one of said email accounts being known, said system comprising:
means for determining, by a statistical study of data relating to the past activity of the email account the state of which is known, at least one predefined indicator relating to said email account (11, 13);
means for determining, in relation to said predefined indicator and at least one predetermined level associated with said indicator, at least one index relating to the past activity of said email account the state of which is known (11, 13);
means for triggering, in relation to said index and a predetermined level associated with said index, a signal called an alarm signal corresponding to said state of said email account the state of which is known (11, 13); and
means for triggering at least one operation, called a management operation, intended to reduce quantitatively the flow of emails relating to said email account the state of which is known, in relation to said alarm signal.

17. System according to claim 16, characterized in that it is implemented for managing the flows of emails between at least one sender email account the state of which is known (11) and at least one recipient email account the state of which is known (13), said management being carried out in relation to at least one pollution index relating to said sender account (11) and/or at least one saturation index (SAT) relating to said recipient account (13).

18. System according to claim 16, characterized in that it also comprises:
means for displaying, at the level of a sender email account (11) the state of which is known, at least one item of information relating to its pollution state, and/or
means for displaying, at the level of a sender email account (11) at least one item of information relating to the declared state of absence (ABS) and/or saturation (SAT) of at least one recipient email account (13) the state of which is known.

19. System according to claim 17, characterized in that it also comprises:
means for displaying, at the level of a sender email account (11) the state of which is known, at least one item of information relating to its pollution state, and/or
means for displaying, at the level of a sender email account (11) at least one item of information relating to the declared state of absence (ABS) and/or saturation (SAT) of at least one recipient email account (13) the state of which is known.
